(19) United States
(12) Patent Application Publication
(10) Pub. No.: US 2008/0005913 A1
(43) Pub. Date: Jan. 10, 2008

(54) POSITION DETECTION ARRANGEMENT FOR A FUNCTIONAL ELEMENT WHICH CAN BE POSITIONED BY A MOTOR IN A MOTOR VEHICLE

(75) Inventor: Checrallah KACHOUH, Dortmund (DE)

Correspondence Address: ROBERTS, MLOTKOWSKI & HOBBES, P. O. BOX 10064, MCLEAN, VA, 22102-8064, US

(73) Assignee: BROSE SCHLIESSSYSTEME GMBH & CO. KG, Wuppertal (DE)

(21) Appl. No.: 11/775,339

(22) Filed: Jul. 10, 2007

(30) Foreign Application Priority Data
Jul. 10, 2006 (DE) 20 2006 010 698.7
Apr. 19, 2007 (DE) 20 2007 005 749.0

(51) Int. Cl. G01B 7/30

(52) U.S. Cl. 33/1 PT

(57) ABSTRACT

A first position detection arrangement for a functional element (1) which can be positioned by a motor in a motor vehicle, a drive arrangement (2) being coupled via a drive train (3) to the functional element (1) and the functional element (1) thus being positionable by a motor, there being two incremental rotary transducers (4, 5) which are assigned to the drive train (3) and there being a control (6) which is coupled to the rotary transducers (4, 5). It is suggested that the arrangement is made such that, when the functional element (1) is being positioned, an offset arises between the rotary transducer signals of the two rotary transducers (4, 5), the control means (6) being designed such that it determines the absolute position of the functional element (1) from the offset.

### BACKGROUND OF THE INVENTION

1. Field of the Invention

This invention relates to a position detection arrangement for a functional element which can be positioned by a motor in a motor vehicle, a drive arrangement being coupled via a drive train to the functional element and the functional element thus being positionable by a motor, there being two incremental rotary transducers which are assigned to the drive train and there being one control means which is coupled to the rotary transducers. Furthermore the invention relates to a drive unit in a motor vehicle for a positionable functional element with a drive arrangement for motorized positioning of the functional element and a position detection arrangement for detecting the position of the functional element of the type indicated above.

2. Description of Related Art

The expression “functional element which can be positioned” should be understood comprehensively here. Accordingly, it includes in general positioning elements in a motor vehicle as well as closure elements like a tailgate, a rear cover, a hood, a cargo space flap, a side door—also a sliding door—and a lifting roof of a motor vehicle. Furthermore windows, mirrors or vehicle seats which can be positioned by a motor are included.

In the course of increasing the comfort of modern motor vehicles, motorized positioning of functional elements, for example, the tailgate of a motor vehicle, is acquiring increasing importance. For this purpose, there is a drive arrangement which is coupled via a drive train to the respective functional element.

A known drive arrangement for a tailgate (German Utility Model DE 20 2005 000 559 U1) has two spindle drives which are coupled, on the one hand, to the body of the motor vehicle, and on the other, to the tailgate. The two spindle drives are located on opposite sides of the tailgate.

Another known drive arrangement for a tailgate (German Utility Model DE 20 2004 016 543 U1 and corresponding U.S. Publication 2006/0108959) is equipped with a push rod drive, the push rod being coupled to a deflection lever which is connected to the tailgate.

In these drive arrangements, the control of the motorized positioning of the functional element acquires special importance. For this purpose, there is a control means which, based on the absolute position of the functional element, sends suitable control signals to the drive arrangement. Here “absolute position” means an indication which provides information about the actual position of the functional element without further computation. In a tailgate this is, for example, an angle indication which is referenced to the part of the body which cannot be positioned.

It is apparent that the control of motorized positioning can only be as good as the position data present in the control means about the current absolute position of the functional element. The position detection arrangement under consideration is used to determine this position data.

The known position detection arrangement (German Patent Application DE 101 45 711 B4 and corresponding U.S. Pat. No. 6,590,357) underlying the invention is equipped with two incremental rotary transducers. In this connection, one rotary transducer is used for detecting the position of the positionable functional element. This detection takes place by counting the pulses produced by the incremental rotary transducer.

The second rotary transducer generates pulses which are offset in phase to the pulses of the first rotary transducer. The rotary transducer signals of the second rotary transducer are used solely for determining the current positioning direction of the functional element.

The problem in the known position detection arrangement is, first of all, the fact that the accuracy which can be achieved with pulse counting is comparatively low. In addition, the control engineering effort to implement it is comparatively high. Finally, in these systems problems often occur in an emergency, for example, when the voltage supply fails. If the absolute position of the functional element is specifically not stored, when the functional element is restarted, there is no longer any information above its absolute position. Then, complex referencing is necessary.

Furthermore, it is pointed out that, for detection of the absolute position of the functional element, rotary transducers which are made as angle encoders are used. These angle encoders produce rotary transducer signals which are coded depending on the angular position and which, for themselves, provide information about the absolute position. These angle encoders are known as single-turn angle encoders and as multi-turn angle encoders. In a single-turn angle encoder, the rotary transducer signals periodically repeat after one complete revolution. In a multi-turn angle encoder, there is coding of the absolute position over several turns.

The use of angle encoders is also known from the field of tailgates and rear covers of motor vehicles (German Patent Application DE 199 44 554 A1). The disadvantage in angle encoders is always the high costs. One example of this is shown by German Patent DE 33 42 940 C2 and corresponding U.S. Pat. No. 4,712,088.

### SUMMARY OF THE INVENTION

A primary object of the invention is to embody and develop the known position detection arrangement such that detection of the absolute position of the functional element can be achieved with high precision, high operating reliability, even in an emergency, and with low costs.

The aforementioned object is achieved in a position detection arrangement of the initially mentioned type in which, when the functional element is being positioned, an offset arises between the rotary transducer signals of the two rotary transducers and that the control means determines the absolute position of the functional element from the offset.

What is important, first of all, is the finding that, with two incremental and thus economical rotary transducers, the absolute positions can be easily determined. Provision must simply be made for an offset forming between the rotary transducer signals which continues as the functional element is being positioned, and thus, can be used for determining the absolute position of the functional element. In this connection, it is an indirect measurement of the absolute position of the functional element since the measurement is not taken on the functional element itself, but in the drive train.

In a preferred embodiment, the offset can be easily implemented in that the two incremental rotary transducers are assigned to different drive components of the drive train which turn at different speeds during the positioning of the functional element.

It is of special importance here that the two angle transducers are assigned to selected drive components of the drive train which are present anyway. An additional gear train such as is provided for example in conventional multi-turn angle encoders can fundamentally be omitted.

To ensure that the aforementioned offset between the rotary transducer signals occurs, it is provided that the two rotary transducers each produce rotary transducer signals with different pulse frequencies as the functional element is being constantly positioned. In this connection, there are fundamentally two possibilities for determining the absolute position of the functional element from the rotary transducer signals of the two rotary transducers.

One preferred version of determining the absolute position of the functional element is by the time difference between the pulse of one rotary transducer and the following pulse of the other rotary transducer being used as a measure of the absolute position of the functional element.

Another preferred possibility for determining the absolute position is the phase difference between the current pulse of one rotary transducer and the current pulse of the other rotary transducer being used as a measure of the absolute position of the functional element.

A preferred possibility for the configuration of the rotary transducer as a Hall sensor since Hall sensors are especially economical and at the same time durable.

A preferred configuration that is especially advantageous is when the absolute position of a tailgate or the like of a motor vehicle is being detected, the necessary different rotary speeds can be easily implemented by different triggering of the two spindle drives.

It is likewise advantageous for the configuration of the functional element to be as a tailgate or the like of a motor vehicle. The offset between the rotary transducer signals of the two rotary transducers is implemented here, preferably, by designs of rotary transducer gear trains matched to one another.

According to a second teaching which acquires independent importance, a drive unit for a positionable functional element is provided with the described drive arrangement for motorized positioning of the functional element and the described position detection arrangement for detecting the position of the functional element.

According to a third teaching which likewise acquires independent importance, a functional unit in a motor vehicle is provided with the described functional element, the described drive arrangement and the described position detection arrangement for detecting the position of the functional element.

The invention is explained in detail below with respect to the embodiments shown in the accompanying drawings.

### BRIEF DESCRIPTION OF THE DRAWINGS

FIG. 1 is a schematic side view of the rear of a motor vehicle with a drive arrangement with the tailgate opened,

FIG. 2 shows the drive arrangement of the motor vehicle shown in FIG. 1 with a position detection arrangement in accordance with the invention in a view from the interior of the motor vehicle, encircled details being broken out and enlarged,

FIG. 3 shows a further embodiment of a drive arrangement for the motor vehicle shown in FIG. 1 with another position detection arrangement in accordance with the invention in the unmounted state in a view from overhead,

FIG. 4 is a pulse diagram of the rotary transducer signals of the two rotary transducers of a position detection arrangement in accordance with the invention in constant positioning of the functional element, and

FIG. 5 is a schematic representation of an embodiment of a position detection arrangement in accordance with the invention.

### DETAILED DESCRIPTION OF THE INVENTION

The position detection arrangement in accordance with the invention can be used for all possible functional elements 1, especially closure elements, in a motor vehicle. For this purpose reference is made to the listing of applications in the introductory part of the description, the application to tailgates and side doors being emphasized. The drawings relate to use of the position detection arrangement for a functional element 1 which is made as a tailgate. This should not be interpreted as limiting.

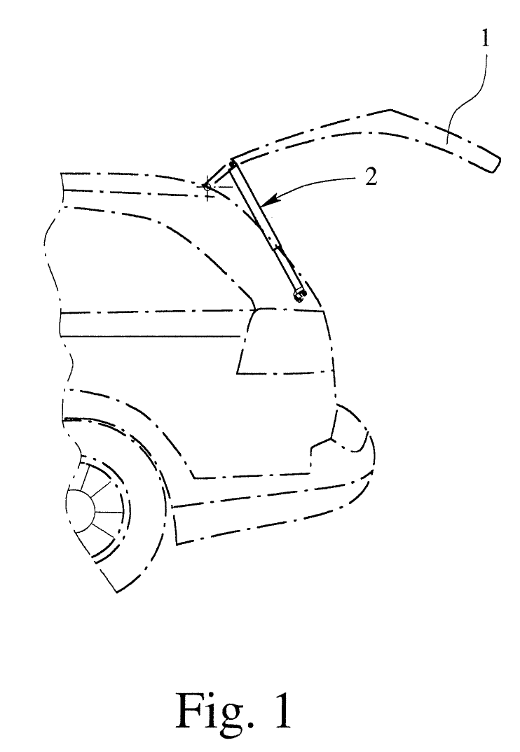

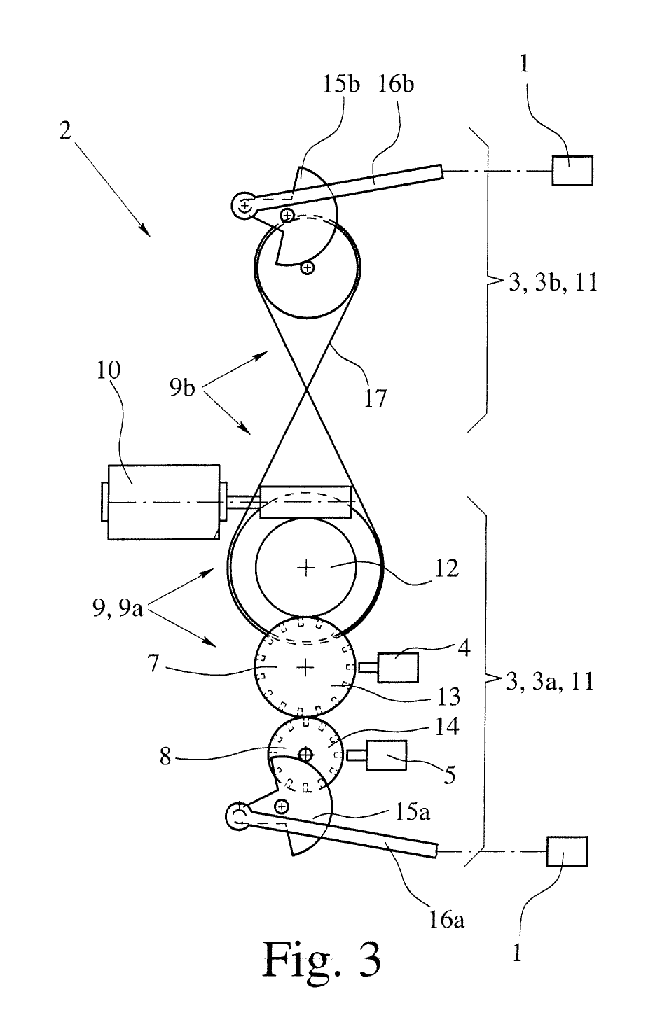

In the embodiment shown in FIGS. 1 & 2, there is a spindle-based drive arrangement 2 for motorized positioning of the tailgate 1. FIG. 3 conversely shows a push rod-based drive arrangement 2 for a tailgate 1. In the two embodiments, it is such that the respective drive arrangement 2 is coupled via the drive train 3 to the tailgate 1, and the tailgate 1 can thus be positioned by a motor. The drive train 3 is generally a component of the drive arrangement 2.

The fundamental manner of operation of the position detection arrangement separate from the illustrated embodiments is first explained below.

The position detection arrangement is equipped with two incremental rotary transducers 4, 5, which are assigned to the drive train 3. Incremental rotary transducers are characterized in that they produce essentially identical pulse-like rotary transducer signals over one complete revolution which periodically repeat with each revolution. In this case, it can also be that only a single pulse is produced per revolution.

Also, there is a control means 6 which is coupled to the rotary transducers 4, 5 and is used, among other things, for evaluation of the rotary transducer signals produced by the rotary transducers 4, 5.

The arrangement is made such that an offset forms between the rotary transducer signals of the two rotary transducers 4, 5 during the positioning of the functional element 1.

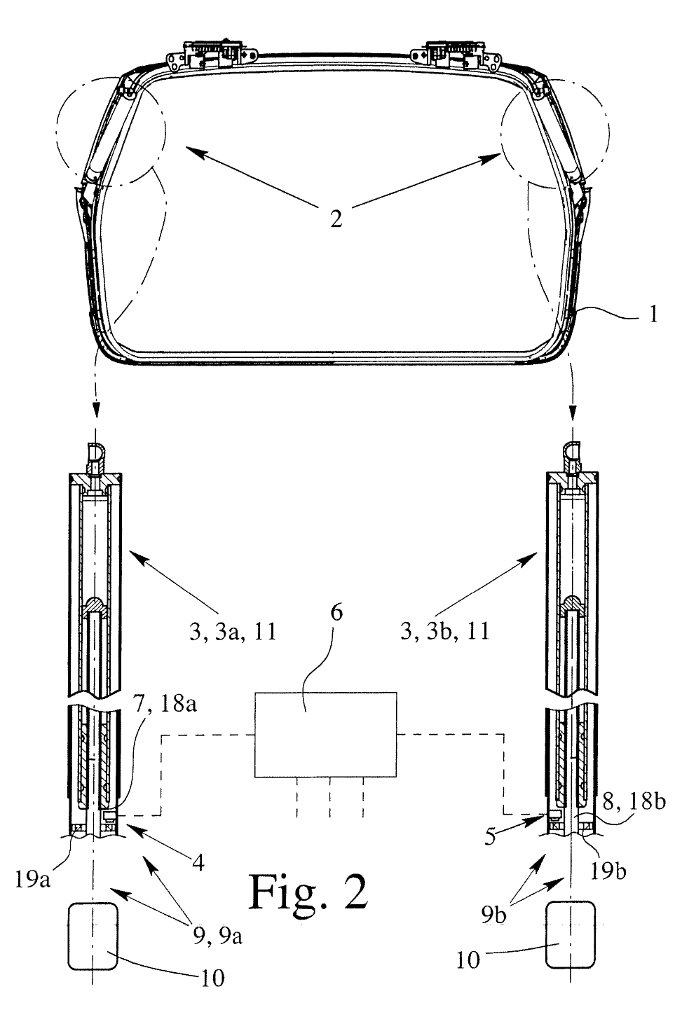

Furthermore, preferably, it is such that, in the installed state, rotary transducer 4 is assigned to the first drive component 7 of the drive train 3 and the second rotary transducer 5 is assigned to the second drive component 8 of the drive train 3, these two drive components 7, 8 turning at different speeds as the functional element 1 is being positioned (FIGS. 2, 3). With the different rotary speeds of the two drive components 7, 8, an offset between the two pulse-like rotary transducer signals which continues during positioning of the functional element 1 can be achieved.

It has already been explained that the resulting offset can be used as a measure for the current absolute position of the functional element 1. Accordingly, it is provided that the control means 6 is designed such that it determines the current absolute position of the functional element 1 therefrom. This design of the control means 6 comprises both its hardware and its software.

Due to the different rotary speeds of the two aforementioned drive components 7, 8, it is such that the rotary transducers 4, 5 each produce rotary transducer signals with different pulse frequencies for the assumed constant positioning of the functional element 1, and one pulse frequency may not be an integral multiple of the other pulse frequency. This ensures that the offset between the rotary transducer signals continues over several revolutions of the two drive components 7, 8, as described above.

A configuration is especially practical in which one pulse frequency differs only slightly from the other pulse frequency. Thus, a relatively large measurement range can be implemented.

Preferably, the arrangement is made such that the offset over the entire positioning path of the functional element 1 is not greater than one period of the rotary transducer signal with the higher pulse frequency, since only in this way is unequivocal assignment of the offset to the position of the functional element 1 possible. Otherwise, provision must be made for storage of each exceeding of this maximum offset amount and for this to be taken into account when the absolution position is determined. This consideration again proceeds from the situation of constant positioning of the functional element 1.

In an especially preferred configuration, the arrangement is made such that the two rotary transducers 4, 5 produce rotary transducer signals with an at least qualitatively identical pulse shape when the functional element 1 is being positioned. This means that the individual pulses viewed on the time axis can be stretched or compressed, however, aside from this compression or stretching, they are identical with respect to their shape. Preferably, all pulses are essentially sinusoidal, parabolic, sawtooth, or the like.

Two preferred possibilities are conceivable for detecting the aforementioned offset between the rotary transducer signals of the two rotary transducers, and thus, the absolution position of the functional element 1 using measurement engineering.

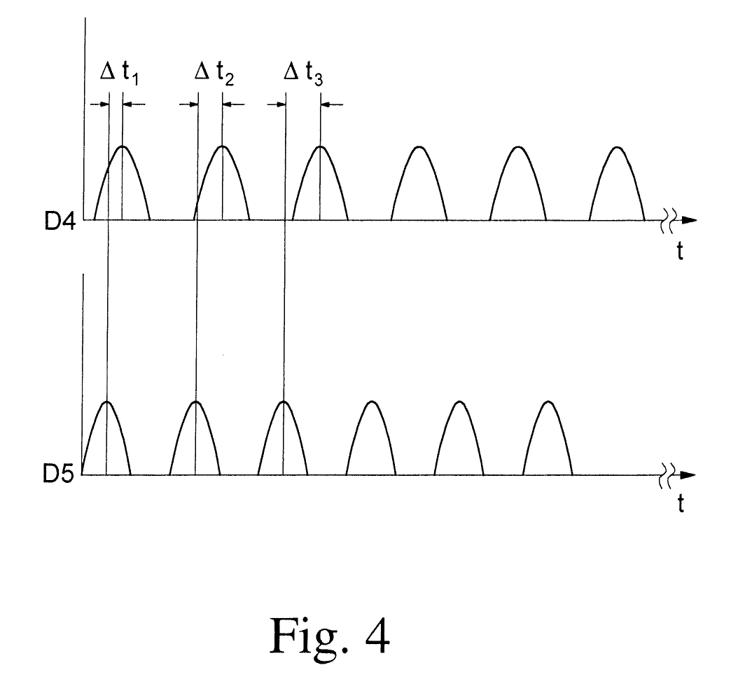

In a first preferred possibility for detecting the offset, it is provided that the control means 6 determines the absolute position of the functional element 1 from the time difference between a pulse of one rotary transducer 4 and the subsequent pulse of the other rotary transducer 5. For example, here, the spacing of the pulse peaks of the two rotary transducer signals is determined. This is shown, for example, in FIG. 4. The continuing offset between the rotary transducer signals (“D4”: rotary transducer 4; “D5”: rotary transducer 5) is shown there by the time differences Δt₁, Δt₂ and Δt₃.

The situation of constant positioning of the functional element 1 underlies the representation in FIG. 4. The pulse shapes are selected there only by way of example.

In the above described determination of the absolute position of the functional element 1 from the time difference, it must be considered that this time difference varies with the positioning speed of the functional element 1. Accordingly, it is necessary to reference the determined time difference to the respective positioning speed.

The positioning speed can be easily obtained from the values determined previously. Here, it is not important that the actual positioning speed be determined. It is simply necessary to determine a value which constitutes a measure for the current positioning speed. This measure can be determined, for example, from the frequency and/or the wavelength of one of the rotary transducer signals. Motor rpm can also be used as a measure for the positioning speed. Ultimately, the rpm or rotary speed of all components which are coupled by motion to the functional element 1 can be used.

The second preferred possibility for detecting the offset is to have the control means 6 determine the absolute position of the functional element 1 from the phase difference between the current pulse of one rotary transducer 4 and the current pulse of the other rotary transducer 5. This version can be used when the pulses have a shape which can be easily resolved by measurement engineering, for example, a sinusoidal shape, a parabolic shape or a sawtooth shape or the like. Then, the offset between the two rotary transducer signals can be determined accordingly from the phase difference.

Determination of the absolute position of the functional element 1 from the phase difference between the current pulse of one rotary transducer 4 and the current pulse of the other rotary transducer 5 is especially advantageous when, viewed during the positioning of the functional element 1, at any instant, each of the two rotary transducers 4, 5 deliver a rotary transducer signal which provides information about the phase, and thus, about the phase difference. This is, for example the case when these rotary transducer signals are formed of preferably sinusoidal, parabolic or sawtooth pulses which are directly connected to one another. Preferably, it is provided that the phase difference is determined continuously, and not only at certain trigger instants or the like.

Determination of the absolute position of the functional element 1 from the phase difference between the current pulse of one rotary transducer 4 and the current pulse of the other rotary transducer 5 is especially advantageous, since determination of the absolution position is possible without having to move the functional element 1. The determination of the time difference addressed above is not necessary.

Fundamentally, it can be provided that the two rotary transducers 4, 5 be made identically and be assigned only to different drive components 7, 8. In a preferred configuration, however, the rotary transducers 4, 5 are each configured differently. This means that they produce different rotary transducer signals for an assumed identical revolution. For example, it can be provided that the rotary transducers 4, 5 generate rotary transducer signals with a different number of pulses per revolution of the corresponding drive components 7, 8. Thus, the optimum ratio of the pulse frequencies of the rotary transducer signals can be easily set.

Numerous possibilities are conceivable for the mechanical implementation of the rotary transducers 4, 5. For example, the rotary transducers 4, 5 could be made as magnetic, as inductive or as optical sensors.

In one especially preferred embodiment, the rotary transducers 4, 5 are made as Hall sensors which are economical and at the same time durable. Then, the drive components 7, 8 to which the rotary transducers 4, 5 are assigned are provided with a certain number of magnets which run past the Hall sensor when the drive components 7, 8 turn. By increasing the number of magnets, the measurement accuracy can be easily increased.

It can also be advantageous to make the rotary transducers 4, 5 as MR angle sensors or as AMR angle sensors which are then used in the sense of incremental rotary transducers. Thus, high measurement precision can be achieved overall.

The manner of operation of the position detection arrangement in accordance with the invention is explained below using the illustrated and preferred embodiments. Here, the functional element 1, as explained, is made as a closure element “tailgate or the like” of a motor vehicle which can be positioned by a motor by means of the drive arrangement 2. Other closure elements, especially a side door, can be used here.

The drive arrangement 2 has a drive 9 with a motor unit 10 and a downstream gear train 11, the drive 9 acting on the functional element 1 via the drive train 3. As explained, there can also be more than one drive 9.

In the drive arrangement 2 which is shown in FIG. 3, it can be recognized that the gear train 11 is made as multistage gear train 11 (in this connection, first, only the region of the drive arrangement 2 which is the lower one in FIG. 13 is taken into account). Part of the gear train 11 is, in any case, the spur gears 12, 13, 14 in the embodiments shown in FIG. 3. FIG. 3 also shows that the rotary transducer 4 is assigned to the spur gear 13 and the rotary transducer 5 is assigned to the spur gear 14. The rotary transducers 4, 5 are made as Hall sensors. Accordingly, the spur gears 13, 14 are provided with the corresponding magnets on their periphery. The two spur gears 13, 14 are drive components 7, 8 in the aforementioned sensors which turn at different speeds due to their differing diameter.

It is pointed out that the spur gear 14 is connected to a cam 15a with the push rod 16a coupled to it. The push rod 16a is coupled to the tailgate I via drive engineering in the installed state (shown completely schematically in FIG. 1). A second push rod arrangement 15b, 16b is connected to the motor unit 10 via a cable drive or belt drive 17. The second push rod 16b is also coupled by drive engineering to the tailgate 1 in the installed state. The gear train 11, on the one hand, and the cable drive or belt drive 17, on the other hand, are designed such that the push rods 16a, 16b always run synchronously.

Ultimately, in the embodiment shown in FIG. 3, it is such that the drive arrangement 2 has two drives 9a, 9b which act on the functional element 1 via two partial drive trains 3a, 3b. In this connection, the motor unit 10 of one drive 9a is, at the same time, the motor unit 10 of the other drive 9b. The two drives 9a, 9b therefore share one motor unit 10.

This is different in the drive arrangement 2 which is shown in FIGS. 1 & 2. There are two drives 9a, 9b here which are separate from one another, each drive 9a, 9b having its own, only schematically shown motor unit 10 with a downstream gear train 11. The two drives 9a, 9b act via two partial drive trains 3a, 3b on the tailgate 1. It is important here that one rotary transducer 4 is assigned to one drive component 7 of one partial drive train 3a and the other rotary transducer 5 is assigned to one drive component 8 of the other partial drive train 3b, these two drive components 7, 8 turning at different speeds as the functional element 1 is positioned. How this is done will be explained.

In the embodiment shown in FIGS. 1 & 2, the two drives 9a, 9b are made as spindle drives with a spindle-spindle nut gear train. In this connection, one rotary transducer 4 is assigned to one spindle drive 9a and the other rotary transducer 5 is assigned to the other spindle drive 9b. In particular, here, rotary transducer 4 is assigned to the spindle 18a of spindle drive 9a and the other rotary transducer 5 is assigned to the spindle 18b of the other spindle drive 9b. In this preferred embodiment, the two spindles 18a, 18b, therefore, correspond to the drive components 7, 8 in the above sense.

Different rotary speeds for the spindles 18a, 18b can be easily achieved by the corresponding triggering of the motor units of the spindle drives 9a, 9b. In order to achieve synchronous running of the two push rods 16a, 16b in spite of the different rotary speeds of the spindles 18a, 18b, it is proposed that the spindles 18a, 18b of the two spindle drives 9a, 9b have different spindle pitches. Here, it is preferably such that the spindle pitch of the spindle 18a of one spindle drive 9a is roughly 5% greater than the spindle pitch of the spindle 18b of the other spindle drive 9b.

The respective arrangement of the rotary transducers 4, 5 is shown in FIG. 2 by way of an extract. The spindles 18a, 18b here are each equipped with a measurement disk 19a, 19b each of which are provided with a certain number of magnets for the rotary transducers 4, 5 which are preferably made as Hall sensors.

There are numerous other possibilities for arrangement of the two incremental rotary transducers 4, 5. For example, it could be provided in the spindle drives 9a, 9b which are shown in FIGS. 1 & 2 that one rotary transducer 4 is assigned to the motor unit or an interposed gear train section and the second rotary transducer 5 is assigned to the spindle 18a. Then, the two rotary transducers 4, 5 are located within the partial drive train 3a.

It follows from the statements above that the rotary transducers 4, 5 are always assigned elements 4b, 5b, 7, 8, 19a, 19b which are set into rotation and initiate generation of the corresponding rotary transducer signals when the functional element 1 is positioned. These elements are called rotary transducer rotors here. The part of the rotary transducer 4, 5 which works in the manner of a sensor is called a rotary transducer sensor.

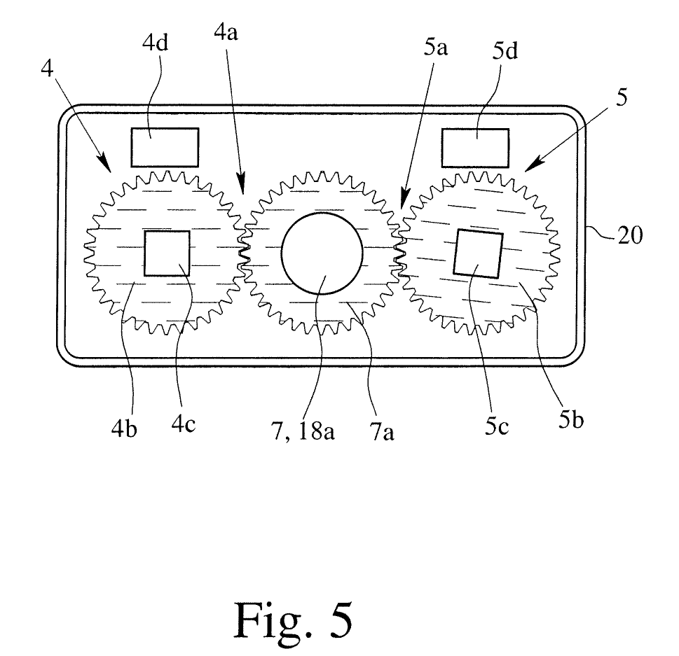

In accordance with the invention, it is not unconditionally necessary for the two rotary transducers 4, 5 to be assigned to different drive components 7, 8 of the drive train 3. In one preferred embodiment, as shown in FIG. 5, it is provided that the two rotary transducers 4, 5 are assigned to the same drive component 7 and preferably that, between the drive component 7 and one rotary transducer 4, a first rotary transducer gear train 4a is connected, and between the drive component 7 and the other rotary transducer 5, a second rotary transducer gear train 5a is connected. The layouts of the rotary transducer gear trains 4a, 5a are matched to one another such that, when the functional element 1 is positioned, an offset forms between the rotary transducer signals of the two rotary transducers 4, 5. As explained above, the absolute position of the functional element 1 can then be determined from this offset. In this preferred configuration, provision must be made, in some way, for the offset to occur between the rotary transducer signals of the two rotary transducers 4, 5. This can be easily achieved by the transmission ratio of one rotary transducer gear train 4a being slightly different from the transmission ratio of the other rotary transducer gear train 5a.

The configuration described last in which the two rotary transducers 4, 5 are assigned to the same drive component 7 can also be achieved with the spindle drive arrangement shown in FIG. 2. Here it is provided that at least one drive 9a, 9b is made as a spindle drive with a spindle-spindle nut gear train and that both one rotary transducer 4 and also the other rotary transducer 5 are assigned to the spindle drive 9a, preferably the spindle 18a of the spindle drive 9a. In this connection, it is preferably also provided that, between the spindle drive 9a, especially the spindle 18a of the spindle drive 9a, and one rotary transducer 4, a first rotary transducer gear train 4a is connected, and between the spindle drive 9a, especially the spindle 18a of the spindle drive 9a, and the other rotary transducer 5, a second rotary transducer gear 5a is connected and that the layouts of the rotary transducer gear trains 4a, 5a are matched to one another such that an offset forms between the rotary transducer signals of the two rotary transducers 4, 5 when the functional element 1 is positioned.

The configuration shown in FIG. 5, in which the two rotary transducers 4, 5 are assigned to a certain drive component 7, is made especially compact. As in the above addressed preferred configurations, the rotary transducers 4, 5 are each equipped with a rotary transducer rotor 4b, 5b and a rotary transducer sensor 4d, 5d, the rotary transducer rotors 4b, 5b each executing several revolutions over the entire positioning path of the functional element 1.

It is of interest here that the rotary transducer rotors 4b, 5b of the two rotary transducers 4, 5 are made identical, an exception still to be explained.

Here, it is preferably such that the rotary transducer rotors 4b, 5b of the two rotary transducers 4, 5 each bear a magnet 4c, 5c. In this connection, the two rotary transducer sensors 4d, 5d are preferably made as MR or as AMR sensors.

Furthermore, the rotary transducer rotors 4b, 5b are each preferably made as a spur gear. They each mesh with the same spur gear 7a of the drive component 7. Thus, the two rotary transducer rotors 4b, 5b form a component of the rotary transducer gear train 4a, 5a; this leads to an especially compact arrangement. The tooth numbers of the rotary transducer rotors 4a, 5b made as a spur gear are only slightly different. Preferably, the two spur gears differ only by one tooth. The rotary transducer rotors 4b, 5b only differ with respect to their tooth numbers, ultimately therefore only with respect to their coupling to the drive component 7. This is the aforementioned exception relative to the otherwise identically made rotary transducer rotors 4b, 5b.

In the preferred configuration shown in FIG. 5, it is noteworthy that the three spur gears 4b, 5b and 7a have a very similar diameter (and similar tooth numbers). It is preferably such that the resulting rpm transmission ratio between the rotary transducer rotors 4b, 5b made as a spur gear and the spur gear 7a of the corresponding drive component 7 is between 0.9 and 1.1, preferably between 0.95 and 1.05, furthermore, preferably between 0.97 and 1.03. Here, the rpm transmission ratio between one of the two rotary transducer rotors 4b, 5b and the spur gear 7a of the corresponding drive component 7 is preferably 1.0.

The entire position detection arrangement here is located preferably in a common housing 20. This housing 20 is preferably integrated into the housing of the drive arrangement 2.

All the statements that have been made above regarding the structure of the rotary transducers 4, 5 with the rotary transducer rotor 4b, 5b and rotary transducer sensor 4d, 5d also apply accordingly to the configurations shown in FIGS. 2 & 3.

It can be summarized that numerous possibilities are conceivable for the configuration of the rotary transducer gear train 4a, 5a. In the simplest case, in this connection, it is only a single, interposed spur gear, as explained. In the preferred configuration shown in FIG. 5, it is provided that one drive component 7, here the spindle 18a of the spindle drive 9a, bears a spur gear 7a which, on the one hand, meshes with the spur gear 4b which is assigned to the rotary transducer 4 (rotary transducer rotor 4b), and on the other hand, with the spur gear 5b which is assigned to the other rotary transducer 5 (rotary transducer rotor 5b). In this connection, the two spur gears 4b, 5b which are assigned to the rotary transducers 4, 5 have different numbers of teeth so that when the functional element 1 is being positioned, the two spur gears 4b, 5b turn with different speeds.

Fundamentally, there can also be an additional rotary transducer (not shown) to be able to detect the direction of motion of the functional element 1. This other rotary transducer is preferably arranged such that it delivers rotary transducer signals which are offset in phase to the rotary transducer signals of one of the other two rotary transducers 4, 5. In an especially preferred configuration, the other rotary transducer, however, is located directly on the respective motor unit.

Conventionally, the drive arrangement 2 is equipped with a clutch (not shown). Thus, it is possible to also manually position the functional element 1. This is especially advantageous in the configuration of the functional element 1 as a tailgate or the like of a motor vehicle. The rotary transducers 4, 5 are then preferably located on the driven side of the clutch so that manual positioning of the functional element 1 which conventionally takes place with the motor unit shut down can also be detected by the control means 6.

It is especially advantageous in the position detection arrangement in accordance with the invention that referencing after manual positioning of the functional element 1 is not necessary. Then, if the above addressed determination of a time difference is used, only a slow restart of the functional element 1 is necessary until the aforementioned offset between the rotary transducer signals and accordingly the absolute position of the functional element 1 has been determined. Then, normal operation can be restarted. This applies, of course, also to the case in which the power supply fails.

However, it is fundamentally also conceivable that, in addition, the pulses of the rotary transducer signals of the two rotary transducers 4, 5 are counted when the functional element is being positioned in order in turn to be able to determine the absolute position of the functional element 1. Thus, there are two possibilities for determining the absolute position. With suitable compensation, the measurement accuracy can thus be increased.

It is pointed out that the drive component 7 or the drive components 7 to which the rotary transducers 4, 5 are assigned are preferably rotary drive components 7 which execute several revolutions over the entire positioning path of the functional element 1, preferably more than 8, furthermore, preferably more than 10, further preferably more than 15 revolutions.

It is also pointed out that numerous other versions are conceivable for the configuration of the rotary transducer rotors 4b, 5b. In addition to the above addressed versions with magnets, a configuration in the manner of a perforated disk or the like is possible.

According to a second teaching which acquires independent importance, a drive unit for a positionable functional element 1 with the described drive arrangement 2 for motorized positioning of the functional element 1 and of the described position detection arrangement for detecting the position of the functional element 1 is encompassed by the invention.

According to a third teaching which likewise acquires independent importance, moreover a functional unit in a motor vehicle with the described functional element 1, the described drive arrangement 2 and the described position detection arrangement for detecting the position of the functional element 1 is also encompassed by the invention.

All the aforementioned statements on advantages and versions apply accordingly to the two other teachings. This applies especially to possible versions of the functional element 1 which were explained in the introductory part of the description.

What is claimed is:

1. Position detection arrangement for a functional element which can be positioned by a motor in a motor vehicle, comprising:
a drive arrangement coupled via a drive train to the functional element for enabling the functional element to be positioned by a motor,
two incremental rotary transducers assigned to the drive train, and
a control means which is coupled to the rotary transducers,
wherein the drive arrangement is made such that an offset arises between rotary transducer signals of the two rotary transducers and
wherein the control means determines the absolute position of the functional element from said offset.

2. Position detection arrangement in accordance with claim 1, wherein one rotary transducer is assigned to a first drive component of the drive train and the other rotary transducer is assigned to a second drive component of the drive train, wherein the two drive components turn at different speeds as the functional element is being positioned for producing said offset between the rotary transducer signals of the two rotary transducers, and wherein the control means determines an offset of the absolute position of the functional element.

3. Position detection arrangement in accordance with claim 1, wherein each rotary transducer produces rotary transducer signals that have a different pulse frequency from that of the other rotary transducer during positioning movement of the functional element.

4. Position detection arrangement in accordance with claim 3, wherein one pulse frequency is not an integral multiple of the other pulse frequency.

5. Position detection arrangement in accordance with claim 3, wherein one pulse frequency differs only slightly from the other pulse frequency.

6. Position detection arrangement in accordance with claim 3, wherein the two rotary transducers produce rotary transducer signals with an at least qualitatively identical pulse shape during positioning movement of the functional element.

7. Position detection arrangement in accordance with claim 3, wherein the two rotary transducers produce one of essentially sinusoidal, parabolic and saw-tooth rotary transducer signals during positioning movement of the functional element.

8. Position detection arrangement in accordance with claim 1, wherein the control means determines the absolute position of the functional element from a time difference between a pulse of one rotary transducer and a following pulse of the other rotary transducer.

9. Position detection arrangement in accordance with claim 2, wherein the control means determines the absolute position of the functional element from a time difference between a pulse of one rotary transducer and a following pulse of the other rotary transducer.

10. Position detection arrangement in accordance with claim 1, wherein the control means determines the absolute position of the functional element from a difference between a current pulse of one rotary transducer and a current pulse of the other rotary transducer.

11. Position detection arrangement in accordance with claim 2, wherein the control means determines the absolute position of the functional element from a difference between a current pulse of one rotary transducer and a current pulse of the other rotary transducer.

12. Position detection arrangement in accordance with claim 1, wherein one rotary transducer is assigned to a first drive component of the drive train and the other rotary transducer is assigned to a second drive component of the drive train, wherein the rotary transducers are configured differently so that the rotary transducers generate a different number of pulses per revolution of the corresponding drive component.

13. Position detection arrangement in accordance with claim 1, wherein the rotary transducers are one of magnetic sensors, inductive sensors and optical sensors.

14. Position detection arrangement in accordance with claim 12, wherein the rotary transducers are one of Hall sensors, MR angle sensors and AMR angle sensors.

15. Position detection arrangement in accordance with claim 1, wherein the functional element is a closure element of a motor vehicle.

16. Position detection arrangement in accordance with claim 15, wherein the closure element is a tailgate of a motor vehicle.

17. Position detection arrangement in accordance with claim 2, wherein the drive arrangement has at least one drive with a motor unit and a downstream gear train which acts on the functional element via the drive train.

18. Position detection arrangement in accordance with claim 17, wherein the gear train is a multistage gear train and wherein the rotary transducers are assigned to different gear train stages

19. Position detection arrangement in accordance with claim 17, wherein one rotary transducer is assigned to the motor unit and the other rotary transducer is assigned to the gear train.

20. Position detection arrangement in accordance with claim 2, wherein the drive arrangement has two drives which act on the functional element via two partial drive trains and wherein one rotary transducer is assigned to a drive component of one partial drive train and the other rotary transducer is assigned to a drive component of the other partial drive train and wherein the drive components turn at different speeds as the functional element is being positioned.

21. Position detection arrangement in accordance with claim 20, wherein the two drives are spindle drives with a spindle-spindle nut gear train, wherein one rotary transducer is assigned to one spindle drive and the other rotary transducer is assigned to the other spindle drive.

22. Position detection arrangement in accordance with claim 1, wherein the drive train has a plurality of drive components and wherein the two rotary transducers are assigned to the same drive component of the drive train.

23. Position detection arrangement in accordance with claim 22, wherein a first rotary transducer gear train is connected between said drive component and one rotary transducer, wherein a second rotary transducer gear train is connected between the drive component and the other rotary transducer, and wherein the rotary transducer gear trains have layouts that are matched to one another such that an offset forms between the rotary transducer signals of the two rotary transducers when the functional element is being positioned.

24. Position detection arrangement in accordance with claim 1, wherein at least one drive is a spindle drive with a spindle-spindle nut gear train and wherein both rotary transducers are assigned to the spindle drive.

25. Position detection arrangement in accordance with claim 24, wherein a first rotary transducer gear train is connected between the spindle drive and one rotary transducer, wherein a second rotary transducer gear train is connected between the spindle drive and the other rotary transducer and wherein layouts of the rotary transducer gear trains are matched to one another such that an offset forms between the rotary transducer signals of the two rotary transducers when the functional element is positioned.

26. Position detection arrangement in accordance with claim 1, wherein the rotary transducers each have a rotary transducer rotor and a rotary transducer sensor, and wherein the rotary transducer rotors each execute several revolutions over the entire positioning path of the functional element.

27. Position detection arrangement in accordance with claim 26, wherein the rotary transducer rotors are identical.

28. Position detection arrangement in accordance with claim 26, wherein the rotary transducer rotors of the two rotary transducers each bear a magnet.

29. Position detection arrangement in accordance with claim 26, wherein the drive component comprises at least one spur gear, wherein the rotary transducer rotors of the two rotary transducers each comprise a spur gear, and wherein the two rotary transducer rotors each mesh with the same spur gear of the corresponding drive component.

30. Position detection arrangement in accordance with claim 29, wherein the rpm transmission ratio between the spur gears rotary transducer rotors and the associated spur gear of the corresponding drive component is between 0.9 and 1.1.

31. Position detection arrangement in accordance with claim 29, wherein the rpm transmission ratio between the spur gears rotary transducer rotors and the associated spur gear of the corresponding drive component is between 0.97 and 1.03.

32. Drive unit for a positionable functional element, comprising
a drive arrangement for motorized positioning of the functional element and
a position detection arrangement for detecting the position of the functional element,
wherein the drive arrangement, in an installed state, is coupled via a drive train to the functional element,
wherein two incremental rotary transducers are assigned to the drive train and
wherein a control means is coupled to the rotary transducers,
wherein an offset is produced between rotary transducer signals of the rotary transducers when the functional element is being positioned and wherein the control means determines the absolute position of the functional element from the offset between rotary transducer signals.

33. Functional unit in a motor vehicle, comprising:
a functional element which is positioned by a motor,
a drive arrangement and
a position detection arrangement for detecting the position of the functional element,
wherein the drive arrangement is coupled via a drive train to the functional element via which the functional element is positionable by a motor,
wherein two rotary transducers are assigned to the drive train,
wherein a control means is coupled to the rotary transducers,
wherein an offset is produced between rotary transducer signals of the rotary transducers when the functional element is being positioned and wherein the control means determines the absolute position of the functional element from the offset between rotary transducer signals.
